(19) United States
(12) Patent Application Publication
(10) Pub. No.: US 2013/0294093 A1
(43) Pub. Date: Nov. 7, 2013

(54) LIGHTING APPARATUS

(71) Applicant: Teajeong AHN, Seoul (KR)

(72) Inventor: Teajeong AHN, Seoul (KR)

(21) Appl. No.: 13/602,543

(22) Filed: Sep. 4, 2012

(30) Foreign Application Priority Data
May 3, 2012 (KR) 10-2012-0046674

(51) Int. Cl. F21V 29/00

(52) U.S. Cl. 362/373

(57) ABSTRACT

A lighting apparatus as disclosed herein may include a body, a light emitting unit having at least one LED provided over the body, an enclosure provided over the body to enclose the light emitting unit, and an electric module provided in the body and electrically connected to the light emitting unit. The body may include a first heat sink having a first cavity and a second heat sink having a second cavity. The first heat sink may be positioned in the second cavity such that an outer surface of the first heat sink is adjacent to an inner surface of the second heat sink. The first heat sink and the second heat sink are formed of different materials and a conductivity of the first heat sink may be different than a conductivity of the second heat sink.

### CROSS-REFERENCE TO RELATED APPLICATION(S)

This application claims priority under 35 U.S.C. §119 to Korean Application No. 10-2012-0046674, filed in Korea on May 3, 2012, whose entire disclosure is hereby incorporated by reference.

### BACKGROUND

1. Field

A lighting apparatus is disclosed herein.

2. Background

Lighting apparatuses are known. However, they suffer from various disadvantages.

### BRIEF DESCRIPTION OF THE DRAWINGS

The embodiments will be described in detail with reference to the following drawings in which like reference numerals refer to like elements, wherein:

FIG. 1 is a side view showing a lighting apparatus according to an embodiment of the present disclosure;

FIG. 2 is an exploded perspective view of the lighting apparatus shown of FIG. 1;

FIG. 3 is a sectional view of the lighting apparatus of FIG. 1;

FIG. 4 is a perspective sectional view of an outer housing and an inner housing of the lighting apparatus according to an embodiment of the present disclosure; and

FIG. 5 is a sectional view of the outer housing and the inner housing of the lighting apparatus according to an embodiment of the present disclosure.

### DETAILED DESCRIPTION

Reference will now be made in detail to the preferred embodiments of the present disclosure, examples of which are illustrated in the accompanying drawings. The accompanying drawings illustrate exemplary embodiments of the present disclosure and provide a more detailed description of the present disclosure. However, the scope of the present disclosure should not be limited thereto.

The same reference numbers is used throughout the drawings to refer to the same or like parts, and a repeated description thereof will be omitted. In the drawings, dimensions and shapes of respective constituent members may be exaggerated or reduced for clarity of description. Moreover, it will be understood that, although the terms first, second, etc. may be used herein to describe various elements, these elements should not be limited by these terms, and the terms are used simply to discriminate any one element from other elements.

Lighting apparatuses are widely used and may employ various types of light sources. Examples of lighting apparatuses of various types of light sources include incandescent bulbs, fluorescent lamps and discharge lamps. These light sources have been used for a variety of purposes, such as domestic, industrial, and outdoor purposes.

However, light sources operating based upon electrical resistance, such as incandescent bulbs, etc., have problems of low efficiency and high heat loss. Discharge lamps are relatively expensive and exhibit poor energy efficiency. Moreover, fluorescent lamps may be harmful to the environment due to its use of mercury.

To solve disadvantages of these light sources, interest in light emitting diodes (LEDs) is increasing due to a number of advantages, such as high efficiency and realization of various colors and designs, etc. An LED is a semiconductor device that emits light when a forward voltage is applied thereto. The LED has a longer lifespan, lower power consumption, and electrical, optical, and physical properties more suitable for mass production than traditional light sources, and hence, is rapidly replacing incandescent bulbs and fluorescent lamps.

However, the LED generates a large amount of heat during operation, and may suffer from deterioration in efficiency if the heat is not appropriately dissipated. To solve this problem, a heat sink may be provided in an LED based lighting apparatus.

However, the heat sink may increase the overall size of the lighting apparatus. Moreover, the heat sink may be mainly formed of a metal material to provide high thermal conductivity, and hence may increase the total weight of the lighting apparatus. Moreover, the use of heat sinks may increase manufacturing costs, for example, due to relatively higher costs of metal. Accordingly, there is a demand for an improved heat sink that can contribute to a much leaner and lighter design of the lighting apparatus.

The present disclosure is directed to a lighting apparatus that substantially obviates one or more problems due to limitations and disadvantages of the related art. One object of the present disclosure is to provide a lighting apparatus capable of effectively dissipating heat generated from a light emitting unit and an electronic module. Another object of the present disclosure is to provide a lighting apparatus that facilitates easy repair and replacement of some elements. A further object of the present disclosure is to provide a lighting apparatus capable of reducing the size, weight and manufacturing costs of a heat sink while increasing the heat transfer efficiency of the heat sink.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

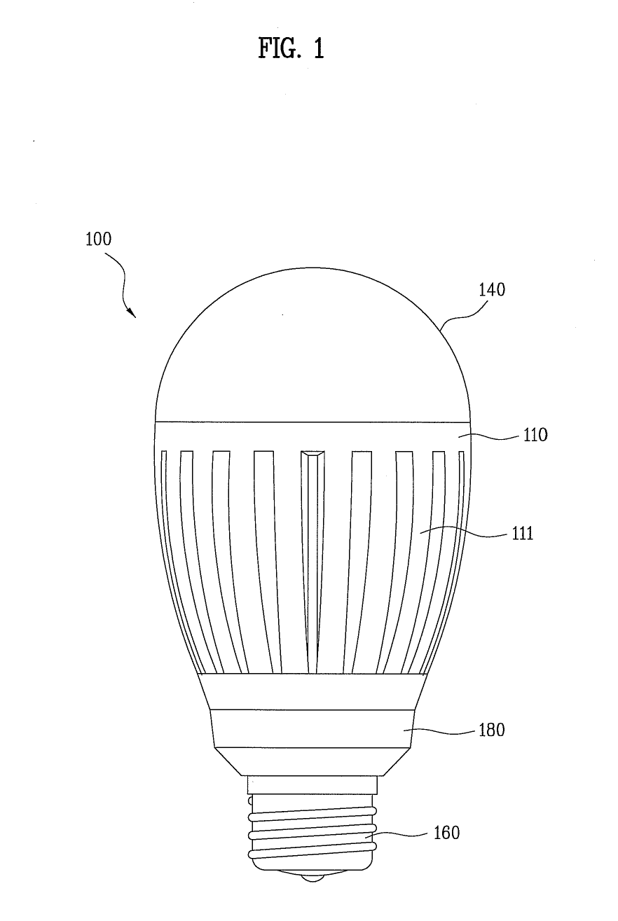

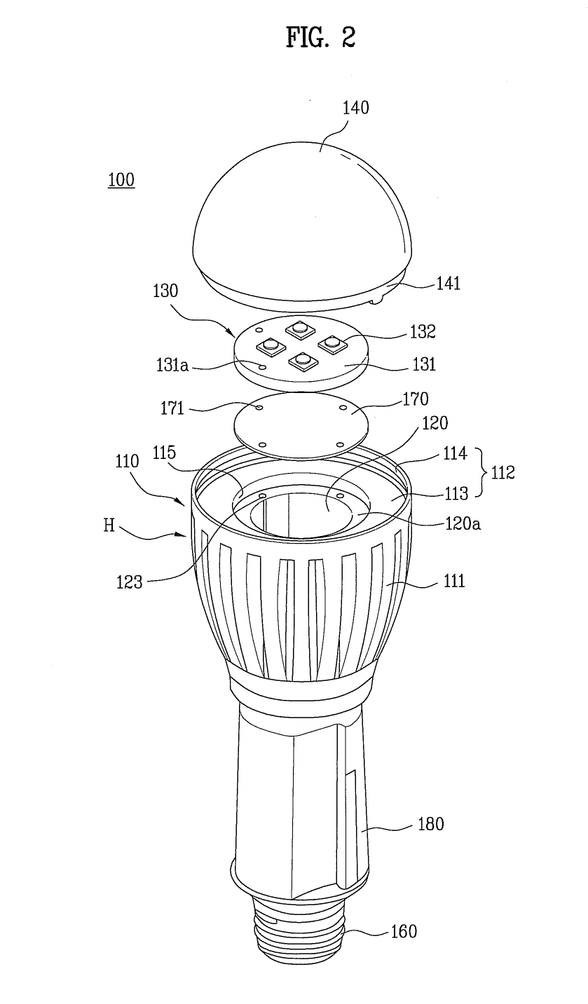

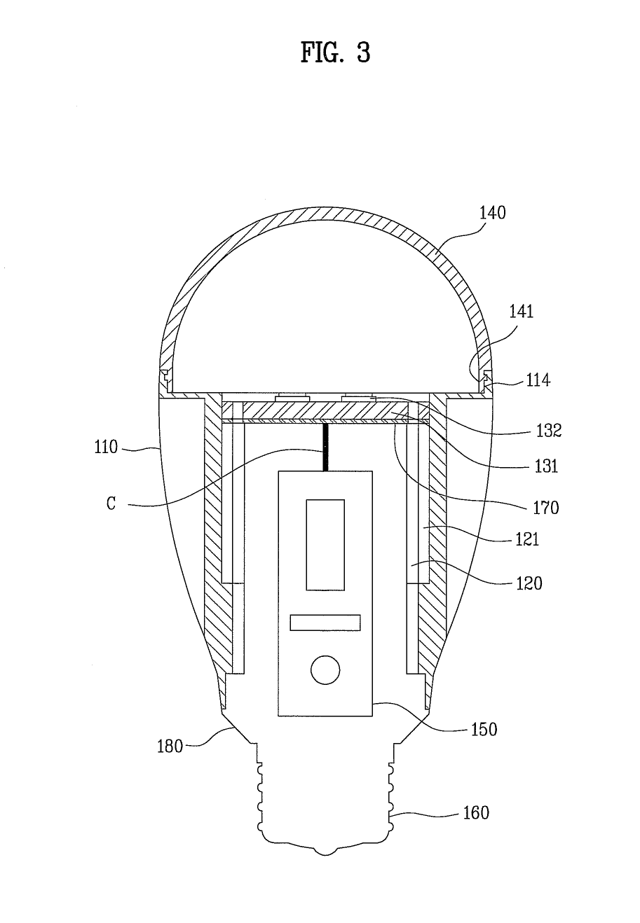

FIG. 1 is a side view of a lighting apparatus according to an embodiment of the present disclosure, FIG. 2 is an exploded perspective view of the lighting apparatus of FIG. 1, and FIG. 3 is a sectional view of the lighting apparatus of FIG. 1.

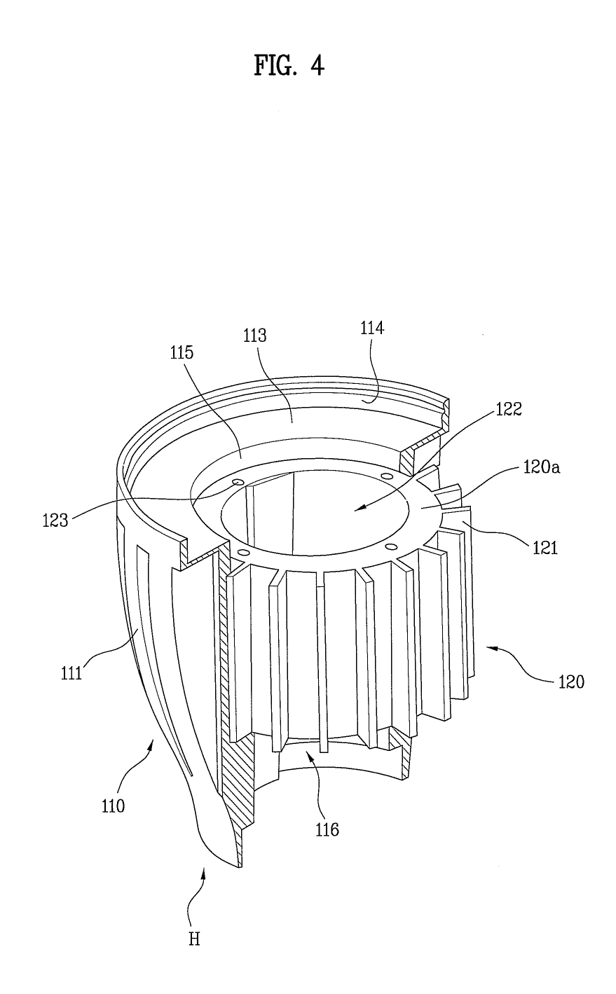

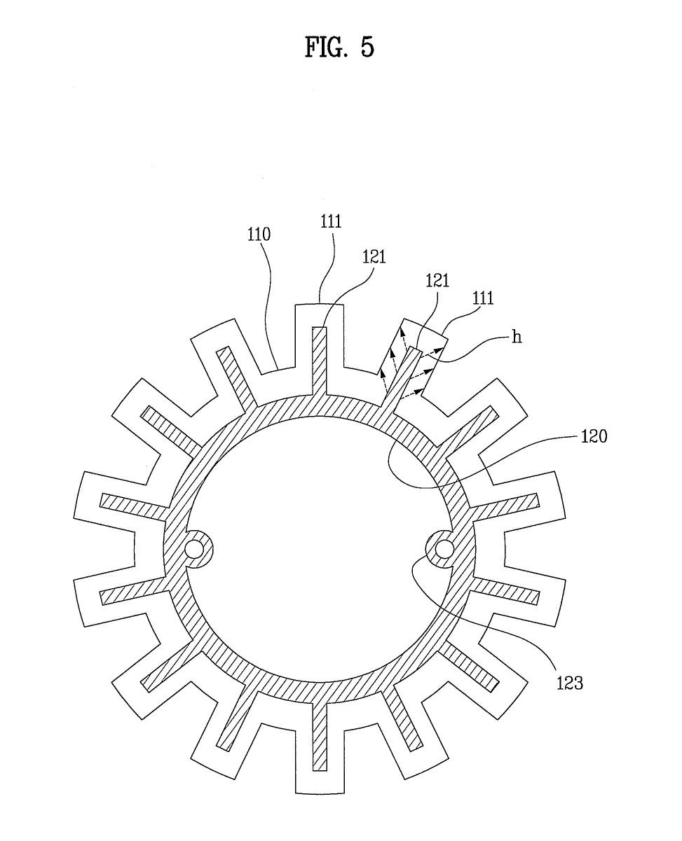

Also, FIG. 4 is a perspective sectional view of an outer housing and an inner housing of the lighting apparatus according to an embodiment of the present disclosure, and FIG. 5 is a sectional view of the outer housing and the inner housing of the lighting apparatus according to an embodiment of the present disclosure.

The lighting apparatus 100 may include an outer housing 110, an inner housing 120, a light emitting unit 130, a enclosure 140, an electronic module 150, a power socket 160, a conductive pad 170 and a case 180 (casing). The outer housing 110 may define the external appearance of the lighting apparatus 100. A cavity 116 may be formed inside the outer housing 110 and the inner housing 120 may be placed in the cavity 116. The inner housing 120 may be configured to longitudinally extend inside the cavity 116.

The inner housing 120 may be formed of a material having different thermal conductivity than the outer housing 110. For example the inner housing 120 may be formed of a material having high thermal conductivity (e.g., metal) and the outer housing 110 may be formed of a material having a lower thermal conductivity (e.g., resin). The combination of the inner and outer housings 120, 110 may form a heat sink as described in further detail hereinafter.

The light emitting unit 130 may be placed over the inner housing 120. The light emitting unit 130 may include a substrate 131 and a plurality of LEDs 132 arranged on the substrate 131. The enclosure 140 may be mounted to the outer housing 110 and may cover the light emitting unit 130. The enclosure may have a variety of shapes, for example, a bulb. The electronic module 150 may be placed in the cavity 116 and electrically connected to the light emitting unit 130. The casing 180 may be inserted into the cavity 116 so as to surround the electronic module 150. The power socket 160 may be mounted to the casing 180.

The aforementioned constituent elements of the lighting apparatus 100 according to the present disclosure will hereinafter be described with reference to the accompanying drawings.

The outer housing 110 (outer heat sink) may define the external appearance of the lighting apparatus 100. In order to dissipate heat generated from the light emitting unit 130 during operation of the lighting apparatus 100, the outer housing 110 may be formed of a light weight yet highly thermally conductive material. The outer housing 110 may be formed of a resin material. Since the outer housing 110 which defines the external appearance of the lighting apparatus 100 has a large surface area that is exposed to ambient air, the outer housing 110 has an important function in dissipating heat generated from the light emitting unit 130.

The cavity 116 may be formed to longitudinally penetrate the outer housing 110, and the inner housing 120 (inner heat sink), the electronic module 150, and the casing 180 as described above may be inserted into the cavity 116. In one embodiment, the outer housing 110 may take the form of a hollow cylinder.

The inner housing 120 may be placed in the cavity 116 of the outer housing 110. The inner housing 120 may include a plurality of fins 121 that protrudes toward the outer housing 110. The fins 121 may serve to increase a surface area of the inner housing 120 in order to increase a contact area between the inner housing 120 and the outer housing 110.

The inner housing 120 may take the form of a longitudinally elongated hollow cylinder, and the plurality of fins 121 may be circumferentially provided at an outer surface of the inner housing 120 so as to protrude radially outward toward the outer housing 110. The height of the inner housing 20 may be greater than a width (diameter) thereof. The light emitting unit 130 may be mounted to the inner housing 120. More specifically, the substrate 131 of the light emitting unit 130 may be coupled to the inner housing 120.

In one embodiment, a height of the inner housing 120 may be greater than or equal to a height of the outer housing 110. In this case, the electronic module 150 and the casing 180 may be placed in a cavity of the inner housing 120.

With the above described configuration, heat generated from the light emitting unit 130 may be transferred to the inner housing 120, and in turn the heat transferred to the inner housing 120 may be dissipated through the outer housing 110. In this way, heat dissipation of the lighting apparatus 100 is accomplished.

In this case, the fins 121 may be provided to increase a contact area between the inner housing 120 and the outer housing 110, thereby functioning to more effectively transfer heat generated from the light emitting unit 130 to the outer housing 110 through the inner housing 120. Accordingly, the outer housing 110 and the inner housing 120 may function as a heat sink H that dissipates heat generated from the light emitting unit 130.

As described above, the outer housing 110 may be formed of a resin material, whereas the inner housing 120 may be formed of a highly thermally conductive material, such as metal. Although it may be advantageous in terms of thermal conductivity that both the outer housing 110 and the inner housing 120 are formed of a metal material, this may be unfavorable in terms of manufacturing costs and weight. For this reason, only the inner housing 120 may be formed of a metal material, and the outer housing 110 may be formed of a resin material.

Although the outer housing 110 formed of a resin material may have a lower thermal conductivity than the inner housing 120 formed of a metal material, owing to the plurality of fins 121 protruding from the inner housing 120 to the outer housing 110, so as to increase a contact area between the inner housing 120 and the outer housing 110, enhanced thermal conductivity between the outer housing 110 and the inner housing 120 may be accomplished. In particular, as illustrated in FIG. 5, the plurality of fins 121 may function to shorten a heat transfer path between the inner housing 120 and the outer housing 110, which may result in enhanced thermal conduction efficiency.

The metal inner housing 120 and the resin outer housing 110 may be separately fabricated and assembled. The inner housing 120 and the outer housing 10 may be separately fabricated through various processes including extrusion molding, injection molding, or another appropriate process. The separate components may then be assembled to form the heat sink body.

In one embodiment, the inner housing 120 and the outer housing may be fabricated to be integrally formed, to form a single body. For example, the inner housing 120 may be formed by extrusion molding, or another appropriate process. The outer housing 110 may be formed by insert injection molding, or another appropriate type of process, to surround or encapsulate the inner housing 111. Since the inner housing 120 is provided with the plurality of longitudinally extending fins 121, extrusion molding the inner housing 120 having the above described configuration may reduce manufacturing costs.

The cavity 116 of the outer housing 110 may be provided with a plurality of grooves, into which the fins 121 of the inner housing 120 are inserted respectively. The number and interval of the grooves may correspond to those of the fins 121.

To increase thermal conduction efficiency, the fins 121 may be arranged to come into surface contact with the grooves, and more particularly to come into close contact with the respective grooves, as illustrated in FIG. 5. Here, integrally forming the outer housing 110 and the inner housing 120 via insert injection molding may be effective.

The inner housing 120 may have a shorter length than that of the outer housing 110. In this case, the inner housing 120 may occupy a partial region of the cavity 116 of the outer housing 110. The light emitting unit 130 and at least a portion of the electronic module 150 and the casing 180 as described above may be arranged in the remaining region of the cavity 116. Of course, it will be understood that the length and diameter of the inner housing 120 may be determined in various ways in consideration of thermal conduction performance and space utility.

The electronic module 150 may include a circuit, which supplies power to the light emitting unit 130 and is electrically connected to the light emitting unit 130. An insulator may be provided to fill the space between the circuit and the case 180 to insulate the circuit. The circuit may include a converter to convert AC power into DC power, and a transducer to adjust the magnitude of voltage. The insulator may be formed of silicone or another appropriate type of material.

The casing 180 may be configured to surround the electronic module 150 and may be inserted into the cavity 116 of the outer housing 110. Referring to FIG. 3, the casing 180 may be inserted into the cavity 116 of the outer housing 110 such that a portion thereof is located within the inner housing 120.

The casing 180 and the cavity 116 of the outer housing 110 may respectively be provided with structures for easy insertion of the casing 180. In one embodiment, the casing 180 may be provided at an outer peripheral surface thereof with guide protrusions, and the outer housing 110 may be provided at an inner peripheral surface thereof with guide grooves for guiding the guide protrusions during insertion of the case 180.

The lighting apparatus 100 may further include a thermal conductive pad 170 placed between the light emitting unit 130 and the inner housing 120. The thermal conductive pad 170 may function to enhance thermal conduction performance between the light emitting unit 130 and the inner housing 120 and to increase a contact area between the light emitting unit 130 and the inner housing 120, thereby achieving enhanced heat dissipation efficiency.

Hereinafter, a configuration of the light emitting unit 130 and the bulb 140 mounted to the outer housing 110 and the inner housing 120 will be described in detail with reference to the accompanying drawings.

Referring to FIGS. 2 and 3, the light emitting unit 130 may be mounted to the inner housing 120. More specifically, the substrate 131 of the light emitting unit 130 may be coupled to the inner housing 120. To this end, the lighting apparatus 100 may further include a fastening member which penetrates the substrate 131 of the light emitting unit 130 to thereby be secured to the inner housing 120.

The fastening member may be a screw. The substrate 131 may have a first fastening hole 131a formed therethrough to accommodate the screw. The inner housing 120 may have a second fastening hole 123 at a position corresponding to the first fastening hole 131a.

In the case in which the thermal conductive pad 170 may be interposed between the light emitting unit 130 and the inner housing 120, the thermal conductive pad 170 may have a third fastening hole 171 at a position corresponding to the first fastening hole 131a and the second fastening hole 123. Through this configuration using the fastening member, the light emitting unit 130 and the thermal conductive pad 170 may be secured to the inner housing 120.

More specifically, the outer housing 110 may be provided with a recess 112. The recess 112 may have a bottom surface 113 and a sidewall 114. A through-hole 115 may be formed at the bottom surface 113 to expose the cavity 116. That is, the through-hole 115 may form the upper region of the cavity 116, as illustrated in FIG. 2. The recess 112 may be provided at the opposite region of a region into which the casing 118 is inserted (for convenience, referred to as a lower end of the outer housing 110). In other words, the recess 112 may be provided at a region where the light emitting unit 130 and the bulb 140 are placed (for convenience, referred to as an upper end of the outer housing 110).

In this case, the substrate 131 of the light emitting unit 130 may be located in the through-hole 115 of the outer housing 110. Specifically, the substrate 131 of the light emitting unit 130 may be oriented such that a lateral surface thereof faces an inner side surface of the through-hole 115 and a lower surface of the substrate 131 faces an upper surface 120a of the inner housing 120.

As described above, the inner housing 120 may have a shorter length (height) than that of the outer housing 110 and may be located such that a predetermined space is defined between the upper surface 120a thereof and the through-hole 115. The light emitting unit 130 may be provided in the space between the through-hole 115 and the upper surface 120a of the inner housing 120.

The through-hole 115 of the recess 112 may function as a guide to align the light emitting unit 130 to an accurate mounting position, which ensures easy assembly. Further, since the inner housing 120 takes the form of a hollow cylinder, the electronic module 150 and the light emitting unit 130 may be electrically connected to each other through the interior space of the inner housing 120.

In one embodiment, the upper surface of the substrate 131 may be substantially flush with the bottom surface 113 of the recess 112 (e.g. coplanar), or may be raised from the bottom surface 113 of the recess 112 toward the bulb 140. Moreover, in one embodiment the inner housing 120 may include a mounting surface for the substrate 131 and pad 170. The mounting surface may be formed at the upper surface 120a to effectively increase the size of the upper surface 120a. In other words, the upper surface 120a may extend to cover a portion of the cavity 116 or through-hole 115. The mounting surface may be formed to be integral to the inner housing 120. In this way, thermal conductivity between the substrate 131 and the heat sink H may be improved.

Referring to FIGS. 2 and 3, the sidewall 114 of the recess 112 may be provided with a first helix, and the bulb 140 may be provided with a second helix engaged with the first helix (e.g., threads). In this way, the first helix and the second helix may be engaged with each other when rotating the bulb 140 or the outer housing 110 in a state in which the bulb 140 comes into contact with the sidewall 114 of the recess 112.

A configuration for dissipating heat generated from the light emitting unit 130 will hereinafter be described in detail with reference to the accompanying drawings.

Referring to FIGS. 2 to 5, as described above, the substrate 131 of the light emitting unit 130 may be located such that the lateral surface thereof faces the inner periphery of the through-hole 115 and the bottom surface thereof faces the upper surface 120a of the inner housing 120. Heat from the lateral surface of the substrate 131 of the light emitting unit 130 may be transferred to the outer housing 110, and heat from the bottom surface of the substrate 131 may be transferred to the inner housing 120 and then to the outer housing 110.

The inner housing 120 may be provided with the plurality of fins 121 protruding toward the outer housing 110. Since the fins 121 increase a contact area between the inner housing 120 and the outer housing 130, enhanced thermal conductivity may be accomplished.

Further, owing to the fins 122 protruding toward the outer housing 110, a heat transfer path h between the inner housing 120 and an outer surface (air contact surface) of the outer housing 110 may be shortened, which results in enhanced heat transfer efficiency.

In another embodiment of the present disclosure, the lighting apparatus 100 may include a plurality of first fins 111. The lighting apparatus 100 may include a first heat sink 110 having the cavity 116, and a second heat sink 120, which is placed in the cavity 116. In this embodiment, the first fins 111 may be provided on an outer surface of the first heat sink 110 to extend outward therefrom. The second heat sink 120 may include a plurality of second fins 121 that protrude toward the first fins 111. The lighting apparatus 100 may further include the light emitting unit 130 having the substrate 131 mounted to the second heat sink 120 and the plurality of LEDs 132 arranged on the substrate 131, the bulb 140 mounted to the first heat sink 110 so as to surround the light emitting unit 130, the electronic module 150 placed in the cavity 116 and electrically connected to the light emitting unit 130, the casing 180 inserted into the cavity 116 so as to surround the electronic module 150, and the power socket 160 mounted to the casing 180.

The first heat sink of this embodiment may correspond to the outer housing 110 as previously described. However, in this embodiment, the first heat sink 111 (e.g., outer housing) may include, the plurality of first fins 111 provided at an outer peripheral surface thereof.

The first fins 111 may function to increase a contact area between the first heat sink 110 and outside air, thereby increasing heat dissipation efficiency. The second heat sink 120 corresponds to the above described inner housing 120, and the second fins 121 protrude toward the first fins 111.

As described above, the first heat sink 110 may be formed of a resin material for reduction of manufacturing costs, and the second heat sink 120 may be formed of a metal material. Also, the second heat sink 120 may be formed by extrusion molding, and the first heat sink 110 and the second heat sink 120 may be formed integrally by insert injection molding. The first and second heat sink 110, 120 may also be formed as separate structures which may be assembled together.

Referring to FIG. 5, the cavity 116 of the first heat sink 110 may be provided with a plurality of grooves indented toward the first fins 111, and the second fins 121 of the second heat sink 120 may be inserted into the grooves. The grooves may be formed to extend laterally into the first fins 111, as illustrated in FIG. 5. In this way, heat generated from the light emitting unit 130 may be transferred to the first fins 111 of the first heat sink 110 through the second fins 121 of the second heat sink 120.

In this case, owing to the second fins 121 protruding into the first fins 111 of the first heat sink 110, a heat transfer path h between the second heat sink 120 and the outer peripheral surface of the first heat sink 110, e.g., surfaces of the first fins (air contact surface), which results in enhanced heat transfer efficiency.

Further, as described above, the light emitting unit 130 may be located in the cavity 116 of the first heat sink 110. Thus, heat from the lateral surface of the substrate 131 may be transferred to the first heat sink 110, and heat from the rear surface of the substrate 131 may be transferred to the first heat sink 110 through the second heat sink 120.

The present embodiment is identical to the above described embodiment except for the fact that the first heat sink 110 is provided with the first fins 111, and thus a repeated description thereof will be omitted.

As is apparent from the above description, a lighting apparatus as broadly described and embodied herein is capable of effectively dissipating heat generated from a light emitting unit and an electronic module. Further, the lighting apparatus may increase the ease in repairing and replacing of some elements. Furthermore, the lighting apparatus is capable of reducing the weight and manufacturing costs of a heat sink as well as increasing the heat transfer efficiency of the heat sink.

In one embodiment, a lighting apparatus may include a body, a light emitting unit having at least one LED provided over the body, an enclosure provided over the body to enclose the light emitting unit, and an electric module provided in the body and electrically connected to the light emitting unit, wherein the body includes a first heat sink having a first cavity and a second heat sink having a second cavity, the first heat sink being positioned in the second cavity such that an outer surface of the first heat sink is adjacent to an inner surface of the second heat sink, and wherein the first heat sink and the second heat sink are formed of different materials.

A conductivity of the first heat sink and a conductivity of the second heat sink may be different. The first heat sink may be formed of a material having a higher thermal conductivity than the second heat sink. The first heat sink may be formed of a metal material and the second heat sink may be formed of a resin material.

The first heat sink and the second heat sink may be integrally formed. The first heat sink may be formed by extrusion molding, and the second heat sink may be formed by insert injection molding to encapsulate the first heat sink. The first heat sink may be removably placed in the second cavity of the second heat sink.

The first heat sink may have a plurality of fins that radially extend outward and the second heat sink may have a plurality of grooves formed on the inner surface of the second heat sink. The plurality of fins may be positioned in the plurality of grooves. The second heat sink may have a plurality of fins that radially extend outward. The plurality of grooves may be formed to extend into a corresponding fin of the second heat sink. The light emitting unit may be mounted to the first heat sink.

A bottom surface of the substrate may be placed over an upper surface of the first heat sink and a side surface of the substrate may be adjacent to the inner surface of the second heat sink. The lighting apparatus may further include a thermal conductive pad disposed between the bottom surface of the substrate and the upper surface of the first heat sink. A height of the first heat sink may be greater than a width of the first heat sink. A height of the first heat sink may be less than a height of the second heat sink.

In one embodiment, a lighting apparatus may include a first heat sink having a plurality of first fins and a cavity, a second heat sink disposed in the cavity and having a plurality of second fins that protrude toward the first fins, the second heat sink being formed of a material having a different thermal conductivity than the first heat sink, a light emitting unit including a substrate mounted to the second heat sink and a plurality of LEDs mounted on the substrate, a bulb mounted to the first heat sink and configured to surround the light emitting unit, an electronic module disposed in the cavity and electrically connected to the light emitting unit, a case inserted into the cavity and configured to surround the electronic module, and a power socket mounted to the case.

The first heat sink may be formed of a resin material and the second heat sink may be formed of a metal material. The cavity of the first heat sink may be provided with a plurality of grooves that extend toward the first fins, and wherein the second fins of the second heat sink are placed in the grooves. The second heat sink may be formed by extrusion molding, and the first heat sink may be formed around the second heat sink by insert injection molding. The second heat sink may be removably placed in the cavity of the first heat sink. A height of the second heat sink may be greater than a width of the second heat sink, and a height of the first heat sink may be less than the height of the second heat sink.

In one embodiment, a lighting apparatus may include a heat sink including an outer housing, which defines the external appearance of the lighting apparatus and has a cavity, and an inner housing, which is placed in the cavity to longitudinally extend and is formed of a material having a different thermal conductivity than the outer housing, a bulb mounted to the outer housing, a light emitting unit placed in the bulb and having a substrate and a plurality of light emitting diodes (LED) arranged on the substrate, an electronic module placed in the cavity and electrically connected to the light emitting unit, a case inserted into the cavity and configured to surround the electronic module, and a power socket mounted to the case.

The inner housing may be formed of a material having a higher thermal conductivity than the outer housing. The inner housing may be formed of a metal material, and the outer housing may be formed of a resin material. The inner housing may be formed by extrusion molding, and the inner housing and the outer housing may be formed by insert injection molding. Moreover, the inner housing may have a plurality of fins protruding toward the outer housing, and the cavity of the outer housing may be provided with a plurality of grooves, into which the fins of the inner housing are inserted.

The light emitting unit may be mounted to the inner housing. The lighting apparatus may further include a fastening member penetrating the substrate of the light emitting unit to thereby be secured to the inner housing. The outer housing may have a recess, the bulb may be mounted to a sidewall of the recess, and a through-hole may be formed in a bottom surface of the recess and may be connected to the cavity. The sidewall of the recess may be provided with a first helix, and the bulb may be provided with a second helix engaged with the first helix. The substrate of the light emitting unit may be placed inside the through-hole.

Heat from a lateral surface of the substrate may be transferred to the outer housing, and heat from a rear surface of the substrate may first be transferred to the inner housing and then to the outer housing. The lighting apparatus may further include a thermal conductive pad placed between the light emitting unit and the inner housing.

In one embodiment, a lighting apparatus may include a first heat sink having a plurality of first fins and a cavity, a second heat sink placed in the cavity, the second heat sink having a plurality of second fins protruding toward the first fins and being formed of a material having a different thermal conductivity than the first heat sink, a light emitting unit having a substrate mounted to the second heat sink and a plurality of LEDs arranged on the substrate, a bulb mounted to the first heat sink and configured to surround the light emitting unit, an electronic module placed in the cavity and electrically connected to the light emitting unit, a case inserted into the cavity and configured to surround the electronic module, and a power socket mounted to the case.

The first heat sink may be formed of a resin material, and the second heat sink may be formed of a metal material. The cavity of the first heat sink may be provided with a plurality of grooves indented toward the first fins, the second fins of the second heat sink may be inserted into the grooves, and heat generated from the light emitting unit may be transferred to the first fins of the first heat sink through the second fins of the second heat sink. The light emitting unit may be located in the cavity, such that heat from a lateral surface of the substrate is transferred to the first heat sink, and heat from a rear surface of the substrate is first transferred to the second heat sink and then to the first heat sink.

The lighting apparatus may further include a fastening member penetrating the substrate of the light emitting unit to thereby be secured to the second heat sink. Moreover, the second heat sink may be formed by extrusion molding, and the first heat sink and the second heat sink may be formed by insert injection molding.

Any reference in this specification to “one embodiment,” “an embodiment,” “example embodiment,” etc., means that a particular feature, structure, or characteristic described in connection with the embodiment is included in at least one embodiment of the disclosure. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A lighting apparatus comprising:
a body;
a light emitting unit having at least one LED provided over the body;
an enclosure provided over the body to enclose the light emitting unit; and
an electric module provided in the body and electrically connected to the light emitting unit,
wherein the body includes a first heat sink having a first cavity and a second heat sink having a second cavity, the first heat sink being positioned in the second cavity such that an outer surface of the first heat sink is adjacent to an inner surface of the second heat sink, and
wherein the first heat sink and the second heat sink are formed of different materials.

2. The lighting apparatus of claim 1, wherein a conductivity of the first heat sink and a conductivity of the second heat sink are different.

3. The lighting apparatus of claim 2, wherein the first heat sink is formed of a material having a higher thermal conductivity than the second heat sink.

4. The lighting apparatus of claim 2, wherein the first heat sink is formed of a metal material and the second heat sink is formed of a resin material.

5. The lighting apparatus of claim 4, wherein the first heat sink and the second heat sink are integrally formed.

6. The lighting apparatus of claim 4, wherein the first heat sink is formed by extrusion molding, and the second heat sink is formed by insert injection molding to encapsulate the first heat sink.

7. The lighting apparatus of claim 4, wherein the first heat sink is removably placed in the second cavity of the second heat sink.

8. The lighting apparatus of claim 1, wherein the first heat sink has a plurality of fins that radially extend outward and the second heat sink has a plurality of grooves formed on the inner surface of the second heat sink, the plurality of fins being positioned in the plurality of grooves.

9. The lighting apparatus of claim 8, wherein the second heat sink has a plurality of fins that radially extend outward, the plurality of grooves being formed to extend into a corresponding fin of the second heat sink.

10. The lighting apparatus of claim 1, wherein the light emitting unit is mounted to the first heat sink.

11. The lighting apparatus of claim 10, wherein a bottom surface of the substrate is placed over an upper surface of the first heat sink and a side surface of the substrate is adjacent to the inner surface of the second heat sink.

12. The lighting apparatus of claim 11, further comprising a thermal conductive pad disposed between the bottom surface of the substrate and the upper surface of the first heat sink.

13. The lighting apparatus of claim 1, wherein a height of the first heat sink is greater than a width of the first heat sink.

14. The lighting apparatus of claim 1, wherein a height of the first heat sink is less than a height of the second heat sink.

15. A lighting apparatus comprising:
a first heat sink having a plurality of first fins and a cavity;
a second heat sink disposed in the cavity and having a plurality of second fins that protrude toward the first fins, the second heat sink being formed of a material having a different thermal conductivity than the first heat sink;
a light emitting unit including a substrate mounted to the second heat sink and a plurality of LEDs mounted on the substrate;
a bulb mounted to the first heat sink and configured to surround the light emitting unit;
an electronic module disposed in the cavity and electrically connected to the light emitting unit;
a case inserted into the cavity and configured to surround the electronic module; and
a power socket mounted to the case.

16. The lighting apparatus of claim 15, wherein the first heat sink is formed of a resin material and the second heat sink is formed of a metal material.

17. The lighting apparatus of claim 15, wherein the cavity of the first heat sink is provided with a plurality of grooves that extend toward the first fins, and wherein the second fins of the second heat sink are placed in the grooves.

18. The lighting apparatus of claim 15, wherein the second heat sink is formed by extrusion molding, and the first heat sink is formed around the second heat sink by insert injection molding.

19. The lighting apparatus of claim 15, wherein the second heat sink is removably placed in the cavity of the first heat sink.

20. The lighting apparatus of claim 15, wherein a height of the second heat sink is greater than a width of the second heat sink, and a height of the first heat sink is less than the height of the second heat sink.
